(19) United States
(12) Patent Application Publication
(10) Pub. No.: US 2023/0382025 A1
(43) Pub. Date: Nov. 30, 2023

(54) DEVICE FOR PROCESSING A PARTICLE FOAM MATERIAL TO PRODUCE A PARTICLE FOAM MOULDED PART

(71) Applicant: Siegfried Hofmann GmbH, Lichtenfels (DE)

(72) Inventors: Johannes Schütz, Bamberg (DE); Marcus Schmiedeck, Flöha OT Falkenau (DE)

(21) Appl. No.: 17/641,840

(22) PCT Filed: Sep. 8, 2020
(86) PCT No.: PCT/EP2020/075019

§ 371 Date: Mar. 10, 2022

(30) Foreign Application Priority Data
Sep. 10, 2019 (DE) 102019124302.5

(51) Int. Cl. B29C 44/44; B29C 44/34; B29C 44/60

(52) U.S. Cl. CPC B29C 44/445; B29C 44/3426; B29C 44/60

(57) ABSTRACT

Device (1) for processing a particle foam material for producing a particle foam molded part, comprising:
at least one functional unit (2), through at least portions of which at least one working medium that is or can be used in the operation of the device (1) flows or can flow during operation of the device (1),
at least one supply unit (7) for supplying the or at least one working medium that is or can be used in the operation of the device (1) to the at least one functional unit (2),
at least one discharge unit (10) for discharging the or at least one working medium that is or can be used in the operation of the device (1) from the at least one functional unit (2),
at least one preparation unit (13) which is or can be connected to the at least one supply unit (7) and/or to the at least one discharge unit (10) and is designed for preparing the or at least one working medium that is or can be used in the operation of the device (1).

### CROSS REFERENCE TO RELATED APPLICATIONS

The present specification is a National Phase Entry of International Application No. PCT/EP2020/075019 filed Sep. 8, 2020 and entitled “Device for processing a particle foam material for producing a particle foam molded part” which itself claims the benefit of German Patent Application No. DE 10 2019 124 302.5 filed Sep. 19, 2019, the entirety of each of which is incorporated by reference herein.

### FIELD

The present specification relates to a device for processing a particle foam material for producing a particle foam molded part, comprising at least one functional unit, through at least portions of which at least one working medium that is or can be used in the operation of the device flows or can flow during operation of the device, at least one supply unit for supplying the or at least one working medium that is or can be used in the operation of the device to the at least one functional unit, and at least one discharge unit for discharging the or at least one working medium that is or can be used in the operation of the device from the at least one functional unit.

Corresponding devices, routinely also referred to as molding machines, for processing a particle foam material for producing a particle foam molded part are known in principle from the prior art and typically comprise one or more functional units, to which a working medium, such as steam, can be supplied during operation of corresponding devices or from which a working medium, such as water, can be discharged during operation of corresponding devices.

The working medium discharged from respective functional units of corresponding devices is, to date, typically not prepared on the device side, which is a situation that could be improved in respect of the efficiency of the operation of corresponding devices, in particular from the standpoint of the consumption of energy and media.

### SUMMARY

The problem addressed by the present specification is to provide a device for processing a particle foam material for producing a particle foam molded part that is improved, in particular in respect of the efficiency of operation.

The problem is solved by a device according to claim 1. The claims that are dependent thereon relate to possible embodiments of the device according to claim 1.

A first aspect of the present specification relates to a device for processing a particle foam material for producing a particle foam molded part. The device can also be referred to as or considered to be a molding machine.

The device is generally designed for processing a particle foam material for producing a particle foam molded part. The device is therefore designed for carrying out at least one working process for processing a particle foam material for producing a particle foam molded part. As is clear from the following, an expansion or connection process of a particle foam material for producing a particle foam molded part can be considered to be an example of a corresponding working process.

A particle foam material that can be or is to be processed by means of the device is typically an expandable or expanded plastics particle material. The particle foam material may e.g. be formed by expandable or expanded plastics particles or may comprise expandable or expanded plastics particles. In this context, purely by way of example, reference is made to expanded and/or expandable polypropylene (PP or EPP), expanded and/or expandable polystyrene (PS or EPS) and expanded and/or expandable thermoplastic elastomer (TPE). Mixtures of expandable or expanded particle materials or particles that differ in at least one chemical and/or physical parameter are conceivable; the term “particle foam material” can therefore also cover mixtures of expandable or expanded particle materials or particles that differ in at least one chemical and/or physical parameter.

In the operation of the device, typically at least one working medium is used. A working medium is generally an, in particular liquid, vaporous or gaseous, energy-carrier medium, such as a liquid, i.e. in particular water, steam, i.e. in particular superheated steam, or a gas, which, in the operation of the device, absorbs or outputs energy, i.e. in particular thermal energy, kinematic energy, etc., or is designed to do this.

The device comprises at least one functional unit, through at least portions of which at least one working medium that is or can be used in the operation of the device flows or can flow during operation of the device. Even though one functional unit is predominantly discussed in the following, the corresponding comments also apply analogously to a plurality of functional units.

A corresponding functional unit typically comprises a flow-duct structure comprising at least one flow duct through which the working medium that is or can be used in the operation of the device flows or can flow. A relevant flow duct typically comprises at least one flow-duct inlet, at least one flow-duct outlet and at least one flow-duct path extending between the at least one flow-duct inlet and the at least one flow-duct outlet.

In the following, embodiments of corresponding functional units are set out in an exemplary and non-exhaustive manner:

The or at least one functional unit may e.g. be designed as or comprise a die unit delimiting a molding cavity. A corresponding functional unit may therefore be in the form of a die unit for actually processing a particle foam material for producing a particle foam molded part. As is clear from the following, a corresponding die unit may comprise one or more die unit elements, i.e. a part of the die elements or halves delimiting a molding cavity delimited by the die unit in each case, for example.

Furthermore, the or at least one functional unit may e.g. be designed as or comprise a steam-generating unit for generating steam. A corresponding functional unit may therefore be in the form of a steam-generating unit for generating steam, i.e. in particular superheated steam or saturated steam. A corresponding functional unit may for example be designed for generating steam by converting water into steam, i.e. in particular superheated steam or saturated steam. A corresponding steam-generating unit may comprise one or more steam-generating elements, i.e. heating elements, for example.

Furthermore, the or at least one functional unit may e.g. be designed as or comprise an, in particular chamber-like or chamber-shaped, steam storage unit for storing steam, in particular superheated steam or saturated steam, supplied to a die unit delimiting a molding cavity. A corresponding functional unit may therefore be in the form of a steam storage unit for storing steam, i.e. in particular superheated steam or saturated steam. A corresponding steam storage unit may comprise one or more steam storage elements, i.e. steam chamber elements, for example.

Furthermore, the or at least one functional unit may e.g. be designed as or comprise a pressure-generating unit for generating pressure-modified working medium; “pressure-modified” is in particular understood to mean a working medium having a pressure level that is increased or reduced compared with a starting or reference pressure level. A corresponding functional unit may therefore be in the form of a pressure-generating unit for generating pressure-modified working medium, i.e. in particular compressed air. A corresponding pressure-generating unit may for example be designed for generating compressed air by compressing air or for generating pressure-reduced air by depressurizing compressed air. A corresponding pressure-generating unit may comprise one or more pressure-generating elements, i.e. compressor or depressurizing elements, for example.

Furthermore, the or at least one functional unit may e.g. be designed as or comprise an, in particular chamber-like or chamber-shaped, pressure storage unit for storing pressure-modified, in particular pressure-increased, working medium, for example compressed air, to be supplied to a die unit delimiting a molding cavity. A corresponding functional unit may therefore be in the form of a pressure storage unit for storing pressure-modified working medium, i.e. compressed air, for example. A corresponding pressure storage unit may comprise one or more pressure storage elements, i.e. pressure chamber elements, for example.

Furthermore, the or at least one functional unit may be designed as or comprise a temperature-control unit, which is designed for temperature-controlling at least one additional functional unit, in particular for temperature-controlling a die unit delimiting a molding cavity, of the device. A corresponding functional unit may therefore be in the form of a temperature-control unit for temperature-controlling at least one additional functional unit, such as a die unit, a steam-generating unit, a steam storage unit, etc. A corresponding temperature-control unit may comprise one or more temperature-control elements, i.e. temperature-control duct elements through which a temperature-controllable or temperature-controlled medium flows or can flow, for example.

The device further comprises at least one supply unit for supplying the or at least one working medium that is or can be used in the operation of the device to at least one corresponding functional unit. A corresponding supply unit is therefore designed for supplying the or at least one working medium that is or can be used in the operation of the device to at least one corresponding functional unit. Even though one supply unit is predominantly discussed in the following, the corresponding comments also apply analogously to a plurality of supply units.

A corresponding supply unit typically comprises a flow-duct structure comprising at least one flow duct through which the working medium that is or can be used in the operation of the device flows or can flow. A corresponding flow-duct structure may be formed by one or more line elements. A relevant flow duct typically comprises at least one flow-duct inlet, at least one flow-duct outlet and at least one flow-duct path extending between the at least one flow-duct inlet and the at least one flow-duct outlet. A corresponding supply unit may further comprise a flow-generating unit, which is designed for generating a flow of a working medium to be supplied to a corresponding functional unit or for controlling the flow of a working medium to be supplied to a corresponding functional unit. A corresponding flow-generating unit may e.g. be designed as or comprise a pump unit.

The device further comprises at least one discharge unit for discharging the or at least one working medium that is or can be used in the operation of the device from at least one corresponding functional unit. A corresponding discharge unit is therefore designed for discharging the or at least one working medium that is or can be used in the operation of the device from at least one corresponding functional unit. Even though one discharge unit is predominantly discussed in the following, the corresponding comments also apply analogously to a plurality of discharge units.

A corresponding discharge unit typically comprises a flow-duct structure comprising at least one flow duct through which the working medium that is or can be used in the operation of the device flows or can flow. A corresponding flow-duct structure may be formed by one or more line elements. A relevant flow duct typically comprises at least one flow-duct inlet, at least one flow-duct outlet and at least one flow-duct path extending between the at least one flow-duct inlet and the at least one flow-duct outlet. A corresponding discharge unit may further comprise a flow-generating unit, which is designed for generating a flow of a working medium to be discharged from a corresponding functional unit or for controlling the flow of a working medium to be discharged from a corresponding functional unit. A corresponding flow-generating unit may e.g. be designed as or comprise a pump unit.

It is clear from the above comments that, typically, a corresponding functional unit is or can be fluidically connected to a corresponding supply unit and a corresponding discharge unit. There is therefore typically a fluidic connection (flow connection) between a corresponding functional unit, a corresponding supply unit and a corresponding discharge unit, which connection in particular makes it possible to supply a working medium to be supplied to a functional unit and/or to discharge a working medium to be discharged from a functional unit.

The device further comprises at least one preparation unit that is or can be connected to the supply unit and/or the discharge unit. The preparation unit is designed for preparing the or at least one working medium that is or can be used in the operation of the device. The preparation unit is in particular designed for preparing a working medium to be supplied to a corresponding functional unit by means of a corresponding supply unit and/or for preparing a working medium to be discharged from a corresponding functional unit by means of a corresponding discharge unit. Even though one preparation unit is predominantly discussed in the following, the corresponding comments also apply analogously to a plurality of preparation units.

The preparation unit may be designed for carrying out a plurality of preparation processes, i.e. in particular a plurality of different preparation processes, either at the same time or in a phased manner. A plurality of working media can therefore be prepared by means of the preparation unit either at the same time or in a phased manner. In this process, different preparation processes can interact with one another, in particular by exchanging the energy consumed or released as part of the respective preparation processes. For example, exothermic preparation processes for preparing a first working medium may influence, i.e. in particular induce or assist, endothermic preparation processes for preparing an additional working medium. For example, the thermal energy that is removed or is to be removed from a cooling working medium, i.e. a condensate, for example, in a first preparation process can be supplied to a working medium, i.e. a gas, to be heated, for example, in a second preparation process, or vice versa. The same applies to other types of preparation process. Where necessary, the preparation unit may be equipped with energy exchangers, i.e. in particular heat exchangers, for this purpose.

The preparation unit is in particular designed for preparing a working medium in respect of at least one particular target parameter. A target parameter may be a particular chemical and/or physical property of the working medium that is prepared or is to be prepared which is required or expedient for the use of the prepared working medium in a working process of the device. Therefore, it is possible to prepare a working medium originating from a first working process of the device in respect of a reuse in the same working process of the device or in respect of a use in another working process of the device.

In any case, the preparation unit therefore makes it possible to prepare the or a working medium that is or can be used in the operation of the device and therefore provides the option of reusing a working medium, in particular multiple times, and the option of implementing direct media recycling within the device, which is a considerable improvement over the prior art mentioned at the outset in respect of the efficiency of the operation of the device, for example from the standpoint of the consumption of energy and media.

The preparation unit is typically connected to the device by control technology. Therefore, the operation of the preparation unit, i.e. carrying out one or more preparation processes by means of the preparation unit, can be controlled by a control unit of the device implemented with hardware and/or software. There is therefore an, in particular multidirectional, data and communication connection between the control unit of the device and the preparation unit, i.e. in particular a controller that controls the operation of the preparation unit, via which connection control information controlling at least the operation of the preparation unit can be transferred to the preparation unit. The device may therefore comprise a control unit, which is designed for generating control information controlling the operation of the preparation unit. The control unit may in particular be designed for generating corresponding control information on the basis of current and/or future operational and/or process parameters of the device or a functional unit of the device. As mentioned, the control unit is in a data connection to the preparation unit, i.e. in particular to a controller that controls the operation of the preparation unit, via an, in particular multidirectional, data and communication connection, via which control information controlling at least the operation of the preparation unit can be transferred to the preparation unit.

The control unit may be a central control unit of the device, which is designed for controlling the operation of at least one functional unit of the device and the operation of the preparation unit, i.e. to generate corresponding control information for controlling the operation of at least one functional unit of the device and the preparation unit.

The preparation unit may be structurally connected to the device. For example, the preparation unit may specifically be structurally connected to an, in particular frame-like or rack-like, housing structure of the device (direct connection) or to at least one functional unit of the device that is structurally connected to a housing structure of the device (indirect connection). The preparation unit may therefore e.g. be structurally integrated in the device.

The device may therefore comprise an, in particular frame-like or rack-like, housing structure. The at least one preparation unit may be arranged or formed on or in the housing structure or on or in a functional unit arranged or formed on or in the housing structure, in particular via form-fitting and/or force-locked and/or material-bonded connection interfaces. Therefore, other units of the device, i.e. in particular the functional unit and/or the supply unit and the discharge unit, may also be structurally connected to a housing structure of the device in a corresponding manner.

The preparation unit may be arranged so as to be connected between the supply unit and the discharge unit. The arrangement of the preparation unit relative to the supply unit can therefore be selected such that a working medium prepared by means of the preparation unit can be provided to the supply unit via the preparation unit. The preparation unit may therefore be arranged upstream of the supply unit in terms of flow. The arrangement of the preparation unit relative to the discharge unit can therefore be selected such that a working medium to be prepared by means of the preparation unit can be provided to the preparation unit via the discharge unit. The preparation unit may therefore be arranged downstream of the discharge unit in terms of flow.

The preparation unit may be arranged so as to be connected between the supply unit and the discharge unit, to form a flow circuit unit that forms an, in particular closed, flow circuit for the or at least one working medium that is or can be used in the operation of the device. A corresponding flow circuit unit therefore forms an, in particular closed, flow circuit for the or a working medium, which flow circuit allows working medium to flow from the preparation unit into a functional unit and allows working medium to flow out of the functional unit into the preparation unit. The working medium is typically supplied or flows from the preparation unit into the functional unit via or by means of the supply unit. The working medium is typically discharged or flows out of the functional unit via or by means of the discharge unit. It follows that the flow circuit unit may be formed by the functional unit and/or the preparation unit and/or the supply unit and/or the discharge unit or the functional unit and/or the preparation unit and/or the supply unit and/or the discharge unit may form parts of the flow circuit unit.

The flow circuit unit is typically formed by a flow-duct structure comprising one or more flow ducts. In this case, at least one first flow duct may be designed or provided to allow working medium to be supplied or flow from the preparation unit into the or at least one functional unit, and at least one second flow duct may be designed or provided to allow working medium to be discharged or flow out of the or at least one functional unit into the preparation unit.

The flow ducts forming the flow-duct structure of the flow circuit unit may form a closed flow circuit.

The flow ducts forming the flow-duct structure of the flow circuit unit may extend at least in portions, optionally completely, through the functional unit and/or the preparation unit and/or the supply unit and/or the discharge unit.

The preparation unit may be designed for modifying at least one chemical and/or physical parameter of the or at least one working medium that is or can be used in the operation of the device. The working medium may therefore be prepared by modifying at least one chemical and/or physical parameter of the working medium. What modification to what chemical and/or physical parameter of the working medium specifically needs to be carried out for its preparation typically results from the current chemical and/or physical parameters of the working medium and the chemical and/or physical requirements of a particular working process in which the working medium that is prepared or is to be prepared is intended to be used.

The preparation unit may e.g. be designed for modifying, i.e. in particular for increasing or reducing, the pressure of the or at least one working medium that is or can be used in the operation of the device. The working medium may therefore be prepared by modifying the pressure of the working medium. To do this, the preparation unit may be designed as or comprise a pressure-modifying unit. A corresponding pressure-modifying unit may e.g. be designed as or comprise a compressor unit.

Alternatively or additionally, the preparation unit may be designed for modifying, i.e. in particular for increasing or reducing, the temperature of the or at least one working medium that is or can be used in the operation of the device. Alternatively or additionally, the working medium may therefore be prepared by modifying the temperature of the working medium. To do this, the preparation unit may be designed as or comprise a temperature-modifying unit. A corresponding temperature-modifying unit may e.g. be designed as or comprise a heating and/or cooling unit.

Alternatively or additionally, the preparation unit may be designed for modifying the physical state of the or at least one working medium that is or can be used in the operation of the device. Alternatively or additionally, the working medium may therefore be prepared by modifying the physical state of the working medium. To do this, the preparation unit may be designed as or comprise a physical-state-modifying unit. A corresponding physical-state-modifying unit may e.g. be formed by a corresponding pressure-modifying unit and a corresponding temperature-modifying unit.

Alternatively or additionally, the preparation unit may be designed for modifying, i.e. in particular for increasing or reducing, the energy content of the or at least one working medium that is or can be used in the operation of the device. Alternatively or additionally, the working medium may therefore be prepared by modifying the energy content, i.e. the enthalpy, for example, of the working medium. To do this, the preparation unit may be designed as or comprise an energy-content-modifying unit. A corresponding energy-content-modifying unit may likewise e.g. be formed by a corresponding pressure-modifying unit and a corresponding temperature-modifying unit.

Alternatively or additionally, the preparation unit may be designed for modifying, i.e. in particular for increasing or reducing, the flow properties, in particular the flow speed and/or the flow profile, of the or at least one working medium that is or can be used in the operation of the device. Alternatively or additionally, the working medium may therefore be prepared by modifying the flow properties of the working medium. To do this, the preparation unit may be designed as or comprise a flow-property-modifying unit. A corresponding flow-property-modifying unit may e.g. be formed by a pump unit, a nozzle unit or a diffuser unit.

Alternatively or additionally, the preparation unit may be designed for modifying the chemical composition of the or at least one working medium that is or can be used in the operation of the device. Alternatively or additionally, the working medium may therefore be prepared by modifying the chemical composition of the working medium. To do this, the preparation unit may be designed as or comprise a substance-concentration-modifying unit, which is designed for modifying the concentration of at least one substance forming a constituent of the working medium; a substance can be understood to be a pure substance or a substance compound, for example. A corresponding substance-concentration-modifying unit is in particular designed for modifying, i.e. in particular reducing or increasing, the concentration of at least one substance forming a constituent of the working medium from a first concentration, which may also be 0% or 100% in an extreme case, to a second concentration, which may also be 100% or 0% in an extreme case. One or more substances can therefore also be supplied to or removed from the working medium via a corresponding substance-concentration-modifying unit; the chemical composition of the working medium can be modified in this way.

Alternatively or additionally, the preparation unit may be designed for removing in particular particulate impurities from the or at least one working medium that is or can be used in the operation of the device. Alternatively or additionally, the working medium may therefore be prepared by removing impurities from the working medium and therefore by purifying the working medium. To do this, the preparation unit may be designed as or comprise a purifying unit. A corresponding purifying unit may e.g. be designed as or comprise a filter unit.

The device may comprise at least one, in particular buffer-like or buffer-shaped, storage unit, which is or can be arranged upstream of the preparation unit and is designed for storing working medium to be supplied to the preparation unit, in particular for being prepared therein. Therefore, a working medium to be prepared by means of the preparation unit may first be stored in a corresponding storage unit, i.e. in particular in a corresponding storage volume of a corresponding storage unit, and then, in particular as needed, may be supplied to the preparation unit. A corresponding storage unit may therefore be arranged so as to be connected between the functional unit and the preparation unit, in the region of the discharge unit. Of course, a plurality of corresponding storage units may be arranged between the functional unit and the preparation unit. In this context, both arrangements or configurations of corresponding storage units connected in parallel as well as arrangements or configurations of corresponding storage units connected in series are conceivable. If a plurality of storage units are provided, they may each have identical or different storage volumes.

Alternatively or additionally, the device may comprise at least one, in particular buffer-like or buffer-shaped, storage unit, which is or can be arranged downstream of the preparation unit and is designed for storing working medium to be discharged from the preparation unit, in particular prepared working medium. Therefore, a working medium prepared by means of the preparation unit may first be stored in a corresponding storage unit, i.e. in particular in a corresponding storage volume of a corresponding storage unit, and then, in particular as needed, may be supplied to the functional unit. A corresponding storage unit may therefore be arranged so as to be connected between the preparation unit and the functional unit, in the region of the supply unit. Of course, a plurality of corresponding storage units may be arranged between the preparation unit and the functional unit. In this context, both arrangements or configurations of corresponding storage units connected in parallel as well as arrangements or configurations of corresponding storage units connected in series are conceivable. If a plurality of storage units are provided, they may each have identical or different storage volumes.

It is applicable to all the embodiments that, if a plurality of storage units are provided, these can be designed to be replaceable as needed and/or selectively. Individual storage units, multiple storage units or all the storage units can therefore be replaced as needed and/or selectively; this can provide an option for supplying or discharging a working medium from the device or from the flow system of the device.

As mentioned, a functional unit may be a die unit delimiting a molding cavity. In this case, the supply unit may be designed for supplying the or at least one working medium that is or can be used in the operation of the device to a corresponding functional unit, i.e. in particular to a molding cavity delimited by a corresponding die unit.

The supply unit may in particular be designed for supplying the or at least one working medium that is or can be used in the operation of the device to the die unit for carrying out an expansion process of a particle foam material that is introduced into the molding cavity and is to be processed by means of the device. The working medium that is or can be supplied via the supply unit may therefore require an expansion process, i.e. generally a connection process, of a particle foam material that is introduced into the molding cavity and is to be processed by means of the device. In this case, the working medium is typically an energy carrier, the properties of which allow for a corresponding expansion or connection process of a particle foam material that is introduced into the molding cavity and is to be processed by means of the device. In order to carry out an expansion or connection process, a working medium containing a sufficient quantity of thermal energy, i.e. steam, superheated steam or saturated steam, for example, can be used.

Alternatively or additionally, the supply unit may be designed for supplying the or at least one working medium that is or can be used in the operation of the device for carrying out at least one conditioning process of at least one particle foam molded part that is produced in the molding cavity by an expansion process of a particle foam material that is introduced into the molding cavity and is to be processed by means of the device. A conditioning process may be an inerting, purifying, temperature-controlling or drying process, for example. The working medium that is or can be supplied by the supply unit may therefore require at least one conditioning process, i.e. in particular an inerting, purifying, temperature-controlling or drying process, of a corresponding particle foam molded part. In this case, the working medium is typically an energy carrier, the properties of which allow for a corresponding conditioning process. An inert gas, such as argon, may be used for carrying out an inerting process. A purifying liquid, such as water, or a purifying gas, such as air, in particular purified air, may be used for carrying out a purifying process. A gas, such as air, in particular pressurized or compressed air, may be used for carrying out a drying process. A temperature-controlled liquid, such as temperature-controlled water, or a temperature-controlled gas, such as temperature-controlled air, in particular pressurized or compressed air, may be used for carrying out a temperature-controlling process. The conditioning process may be carried out during or after the production of the particle foam molded part.

Alternatively or additionally, the supply unit may be designed for supplying the or at least one working medium that is or can be used in the operation of the device to the die unit for carrying out at least one conditioning process of the die unit. A conditioning process may be an inerting, purifying, temperature-controlling or drying process, for example. The working medium that is or can be supplied by the supply unit may therefore require at least one conditioning process, i.e. in particular an inerting, purifying, temperature-controlling or drying process, of the die unit. In this case, the working medium is typically an energy carrier, the properties of which allow for a corresponding conditioning process. An inert gas, such as argon, may be used for carrying out an inerting process. A purifying liquid, such as water, or a purifying gas, such as air, in particular purified air, may be used for carrying out a purifying process. A gas, such as air, in particular pressurized or compressed air, may be used for carrying out a drying process. A temperature-controlled liquid, such as temperature-controlled water, or a temperature-controlled gas, such as temperature-controlled air, in particular pressurized or compressed air, may be used for carrying out a temperature-controlling process. The conditioning process may be carried out before, during or after an expansion process of a particle foam material that is introduced into the molding cavity.

Alternatively or additionally, the supply unit may be designed for supplying the or at least one working medium that is or can be used in the operation of the device to a molding cavity delimited by the die unit, in particular in a state in which it is not filled with a particle foam material to be processed, for carrying out at least one conditioning process of the molding cavity. A conditioning process may be an inerting, purifying, temperature-controlling or drying process, for example. The working medium that is or can be supplied by the supply unit may therefore require at least one conditioning process, i.e. in particular an inerting, purifying, temperature-controlling or drying process, of the die unit, i.e. in particular the molding cavity delimited by the die unit. In this case, the working medium is typically an energy carrier, the properties of which allow for a corresponding conditioning process. An inert gas, such as argon, may be used for carrying out an inerting process. A purifying liquid, such as water, or a purifying gas, such as air, in particular purified air, may be used for carrying out a purifying process. A gas, such as air, in particular pressurized or compressed air, may be used for carrying out a drying process. A temperature-controlled liquid, such as temperature-controlled water, or a temperature-controlled gas, such as temperature-controlled air, may be used for carrying out a temperature-controlling process.

Of course, in all cases, combinations of different conditioning processes, i.e. inerting processes and/or purifying processes and/or drying processes and/or temperature-controlling processes, for example, are conceivable. Corresponding conditioning processes may be carried out either at the same time or in a phased manner.

Corresponding conditioning processes, i.e. also the sequence thereof if there are a plurality of different conditioning processes, or corresponding conditioning requirements to be specifically applied in the context of corresponding conditioning processes may be controlled by a control unit of the device implemented with hardware and/or software. The control unit is therefore designed for generating control information controlling the operation of the supply unit and/or the discharge unit for carrying out corresponding conditioning processes. The control unit may in particular be designed for processing system-specific, user-specific or process-specific specifications for one or more conditioning processes, i.e. in particular for generating corresponding control information for controlling the operation of the supply unit and/or the discharge unit on the basis of corresponding specifications.

The supply unit may comprise one or more supply lines, via each of which a particular working medium can be supplied to a die unit, i.e. in particular to a molding cavity delimited by a die unit. A control valve unit is or can be assigned to each supply line. Each control valve unit may be movable, for example by opening a control valve element that is movably mounted between an open position and a closed position, into a first state (open state) in which it is possible to supply a relevant working medium via the relevant supply line to a die unit, i.e. in particular to a molding cavity delimited by a die unit, and may be movable, for example by closing the or a control valve element that is movably mounted between an open position and a closed position, into a second state (closed state) in which it is not possible to supply a relevant working medium via the relevant supply line to a die unit, i.e. in particular to a molding cavity delimited by a die unit.

In an analogous manner, the discharge unit may comprise one or more discharge lines, via each of which a particular working medium can be discharged from a die unit, i.e. in particular from a molding cavity delimited by a die unit. A control valve unit is or can be assigned to each discharge line. Each control valve unit may be movable, for example by opening a control valve element that is movably mounted between an open position and a closed position, into a first state (open state) in which it is possible to discharge a relevant working medium via the relevant discharge line from a die unit, i.e. in particular from a molding cavity delimited by a die unit, and may be movable, for example by closing the or a control valve element that is movably mounted between an open position and a closed position, into a second state (closed state) in which it is not possible to discharge a relevant working medium via the relevant discharge line from a die unit, i.e. in particular from a molding cavity delimited by a die unit.

Respective supply-apparatus-side control valve units and/or respective discharge-apparatus-side control valve units may be operated so as be dependent on or independent of one another, i.e. in particular may be moved into respective first and second states so as be dependent on or independent of one another.

Therefore, it is e.g. possible to supply a first working medium, which can be supplied to a die unit via a first supply line, to the die unit by moving a control valve unit assigned to the first supply line into a first state and to prevent a second working medium, which can be supplied via an additional supply line, from being supplied to the die unit by moving the control valve unit assigned to the additional supply line into the second position. In particular, it is possible to move the control valve units assigned to the respective supply lines into a relevant first state separately, i.e. in particular in a phased manner or separately, such that, in particular when phased, it is possible to supply different working media to a die unit in a separate or isolated manner via respective supply lines. Specifically, by moving a control valve unit assigned to a first supply line into the first state, while all the other control valve units are or have been moved into the second state, a first working medium can be supplied to a die unit and, at a later point in time, by moving a control valve unit assigned to an additional supply line into the first state, while all the other control valve units are or have been moved into the second state, an additional working medium can be supplied to the die unit. The principle can of course also be implemented with more than two supply lines.

In an analogous manner, it is e.g. possible to discharge a first working medium, which can be discharged from a die unit via a first discharge line, from the die unit by moving a control valve unit assigned to the first discharge line into a first state and to prevent a second working medium, which can be discharged via an additional discharge line, from being discharged from the die unit by moving the control valve unit assigned to the additional discharge line into the second position. In particular, it is possible to move the control valve units assigned to the respective discharge lines into a relevant first state separately, i.e. in particular in a phased manner or separately, such that, in particular when phased, it is possible to discharge different working media from a die unit in a separate or isolated manner via respective discharge lines. Specifically, by moving a control valve unit assigned to a first discharge line into the first state, while all the other control valve units are or have been moved into the second state, a first working medium can be discharged from a die unit and, at a later point in time, by moving a control valve unit assigned to an additional discharge line into the first state, while all the other control valve units are or have been moved into the second state, an additional working medium can be discharged from the die unit. The principle can of course also be implemented with more than two supply lines.

The operation of respective supply-apparatus-side control valve units, i.e. in particular the movement thereof into the first or second state, and/or respective discharge-apparatus-side control valve units, i.e. in particular the movement thereof into the first or second state, may be controlled by a control unit implemented with hardware and/or software. The control unit is therefore designed for generating control information controlling the operation of respective supply-apparatus-side and/or discharge-apparatus-side control valve units. The control unit may in particular be designed for processing system-specific, user-specific or process-specific specifications for operating one or more control valve units, i.e. in particular for generating corresponding control information for controlling the operation of respective supply-apparatus-side and/or discharge-apparatus-side control valve units on the basis of corresponding specifications.

If the working medium is a working-medium mixture containing at least two working media that differ in at least one chemical and/or physical parameter, i.e., for example, a mixture of at least one gas and at least one liquid or a mixture of at least two different gases or a mixture of at least two different liquids, the supply unit may be designed for supplying a working-medium mixture containing at least two working media that differ in at least one chemical and/or physical parameter to a die unit, i.e. in particular to a molding cavity delimited by a die unit.

The device may comprise at least one mixing unit, which is or can be assigned to a die unit, i.e. in particular to a molding cavity delimited by a die unit, and is designed for mixing at least two working media that differ in at least one chemical and/or physical parameter to form a working-medium mixture. This can be considered to be a separate aspect of the present specification, but one which can be combined with other aspects.

The mixing unit typically comprises an input, via which at least two working media to be mixed can be supplied to the mixing unit to generate a working-medium mixture, and an output, via which a working-medium mixture generated by means of the mixing unit can be discharged from the mixing unit. The input of the mixing unit is typically connected to at least two supply lines (these supply lines may form parts of a supply unit of the device) for supplying at least two different working media. At least two different working media can be supplied to the mixing unit on the input side via the at least two supply lines. The output of the mixing unit is typically connected to an, i.e. in particular exactly one, discharge line (this discharge line may likewise form part of a supply unit of the device) for discharging a working-medium mixture generated by means of the mixing unit from the mixing unit. A working-medium mixture to be supplied to the die unit can therefore be discharged from the mixing unit on the output side via the discharge line.

The mixing unit is in particular designed for generating working-medium mixtures having a particular composition, i.e. in particular a composition that is or can be predetermined in a system-specific, user-specific or process-specific manner. The mixing unit is therefore designed for generating particular mixing ratios, i.e. in particular mixing ratios of the working media supplied thereto that are or can be predetermined in a system-specific, user-specific or process-specific manner.

In order to produce particular compositions or particular mixing ratios, the mixing unit may comprise at least one mixing space delimiting at least one mixing volume and at least one control valve unit that is or can be assigned thereto. The at least one control valve unit is designed for controlling a supply of a particular quantity of a first working medium provided via a first supply line to be mixed with at least one additional working medium to the at least one mixing space and for controlling a supply of a particular quantity of at least one additional working medium provided via an additional supply line to be mixed with the first working medium to the at least one mixing space.

If a plurality of control valve units are provided, a first control valve unit may be designed for controlling a supply of a particular quantity of a first working medium provided via a first supply line to be mixed with at least one additional working medium to the at least one mixing space; a first supply line may therefore be assigned to the first control valve unit, via which line a corresponding first working medium can be provided. At least one additional control valve unit may be designed for controlling a supply of a particular quantity of at least one additional working medium provided via at least one additional supply line to be mixed with the first working medium to the at least one mixing space; an additional supply line may therefore be assigned to the at least one additional control valve unit, via which line at least one corresponding additional working medium can be provided.

The operation of the mixing unit, i.e. in particular the operation of the at least one control valve unit, may be controlled by a control unit that is or can be assigned to the mixing unit and is implemented with hardware and/or software. The control unit is therefore designed for generating control information controlling the operation of the mixing unit or the at least one control valve unit. The control unit may in particular be designed for processing system-specific, user-specific or process-specific specifications for one or more mixing ratios, i.e. in particular for generating corresponding control information for controlling the operation of the mixing unit or the at least one control valve unit on the basis of corresponding specifications.

A die unit delimiting a molding cavity may comprise at least one, in particular chamber-like or chamber-shaped, working-medium receiving space for receiving steam. This can be considered to be another separate aspect of the embodiments disclosed herein, but one which can be combined with other aspects. A corresponding die unit may therefore delimit at least one internal steam-receiving volume, which is defined by at least one corresponding working-medium receiving space and is designed for receiving steam. The at least one working-medium receiving space is typically delimited by walls of the die unit. The at least one working-medium receiving space is typically integrally formed with the die unit or is integrated therein. At least one of the walls delimiting the at least one working-medium receiving space is equally a wall delimiting the molding cavity delimited by the die unit. Therefore, the at least one working-medium receiving space is typically formed immediately behind a wall of the die unit delimiting the molding cavity, such that a separate steam chamber, as provided in conventional die units, can be omitted.

A corresponding die unit typically comprises one or more flow ducts, via which a working medium can be supplied to a corresponding working-medium receiving space and/or can be discharged from a corresponding working-medium receiving space. In particular, a corresponding die unit comprises at least one first flow duct, which is designed for supplying a working medium, which is in particular a working medium that can be converted into steam in this case, to the at least one working-medium receiving space, and comprises at least one additional flow duct, which is designed for discharging a working medium from the at least one working-medium receiving space. In an exemplary, minimum configuration, the die unit therefore comprises one flow duct for supplying a working medium to the at least one working-medium receiving space and one flow duct for discharging a working medium from the at least one working-medium receiving space.

Typically, the die unit comprises a plurality of die elements, i.e. in particular die halves, delimiting part of the molding cavity delimited by the die unit in each case. Typically, in this case at least one die element is movably mounted relative to another die element in order to produce an open position and closed position of the die unit in at least one degree of freedom.

Analogously to the die unit, a relevant die element may comprise at least one, in particular chamber-like or chamber-shaped, working-medium receiving space for receiving steam. This can be considered to be another separate aspect of the embodiments disclosed herein, but one which can be combined with other aspects. A corresponding die element may therefore delimit at least one internal steam-receiving volume, which is defined by at least one corresponding working-medium receiving space and is designed for receiving steam. The at least one working-medium receiving space is typically delimited by walls of the relevant die element. The at least one working-medium receiving space is typically integrally formed with the relevant die element or is integrated therein. At least one of the walls delimiting the working-medium receiving space is equally a wall delimiting the molding cavity delimited by the relevant die element. A plurality of openings (not shown in greater detail), via which a working medium, such as steam, compressed air, etc., can enter the molding cavity, are made in this wall. Therefore, the at least one working-medium receiving space is typically formed immediately behind a wall of a relevant die element delimiting the molding cavity, such that a separate steam chamber, as provided in conventional die units, can be omitted.

Analogously to the die unit, a corresponding die element typically comprises one or more flow ducts, via which a working medium can be supplied to a corresponding working-medium receiving space and/or can be discharged from a corresponding working-medium receiving space. In particular, a corresponding die element comprises at least one first flow duct, which is designed for supplying a working medium, which is in particular a working medium that can be converted into steam in this case, to the at least one working-medium receiving space, and comprises at least one additional flow duct, which is designed for discharging a working medium from the at least one working-medium receiving space. In an exemplary, minimum configuration, a corresponding die element therefore comprises one (single) flow duct, which is designed for supplying a working medium to the at least one working-medium receiving space and for discharging a working medium from the at least one working-medium receiving space. Typically, however, a corresponding die element comprises at least one flow duct which is designed for supplying a working medium to the at least one working-medium receiving space and for discharging a working medium from the at least one working-medium receiving space and at least one flow duct which is designed for supplying a working medium to the at least one working-medium receiving space and for discharging a working medium from the at least one working-medium receiving space.

The respective flow ducts may be designed as, in particular bore-like or bore-shaped, openings extending through respective die-element bodies. The path of respective flow ducts may be simple or complex; it is conceivable to provide an additively produced construction of the flow ducts, i.e. produced by means of an additive manufacturing method, such as a selective laser-melting method or a binder-jetting method.

Another aspect of the present specification relates to a preparation unit for preparing a working medium for a device for producing a particle foam molded part, in particular for a device according to the first aspect of the present specification. All the information relating to the preparation unit of the device according to the first aspect applies by analogy.

Another aspect of the present specification relates to a method for operating a device for processing a particle foam material for producing a particle foam molded part, which method is characterized in that a working medium that is or can be used in the operation of the device is prepared by means of a preparation unit, in particular by means of a preparation unit integrated in the device. All the information relating to the device according to the first aspect applies by analogy.

### BRIEF DESCRIPTION OF THE DRAWINGS

The aspects of the present specification are explained again on the basis of embodiments in the drawings, in which:

FIG. 1 is a schematic diagram of a device for processing a particle foam material for producing a particle foam molded part according to an embodiment.

FIG. 2 is a schematic diagram of a device for processing a particle foam material for producing a particle foam molded part according to an embodiment.

FIG. 3 is a schematic diagram of a device for processing a particle foam material for producing a particle foam molded part according to an embodiment.

FIG. 4 is a schematic diagram of a device for processing a particle foam material for producing a particle foam molded part according to an embodiment.

FIG. 5 is a schematic diagram of a device for processing a particle foam material for producing a particle foam molded part according to an embodiment.

FIG. 6 is a schematic diagram of a device for processing a particle foam material for producing a particle foam molded part according to an embodiment.

FIG. 7 is a schematic diagram of a device for processing a particle foam material for producing a particle foam molded part according to an embodiment.

FIG. 8 is a schematic diagram of a device for processing a particle foam material for producing a particle foam molded part according to an embodiment.

FIG. 9 is a schematic diagram of a device for processing a particle foam material for producing a particle foam molded part according to an embodiment.

### DETAILED DESCRIPTION

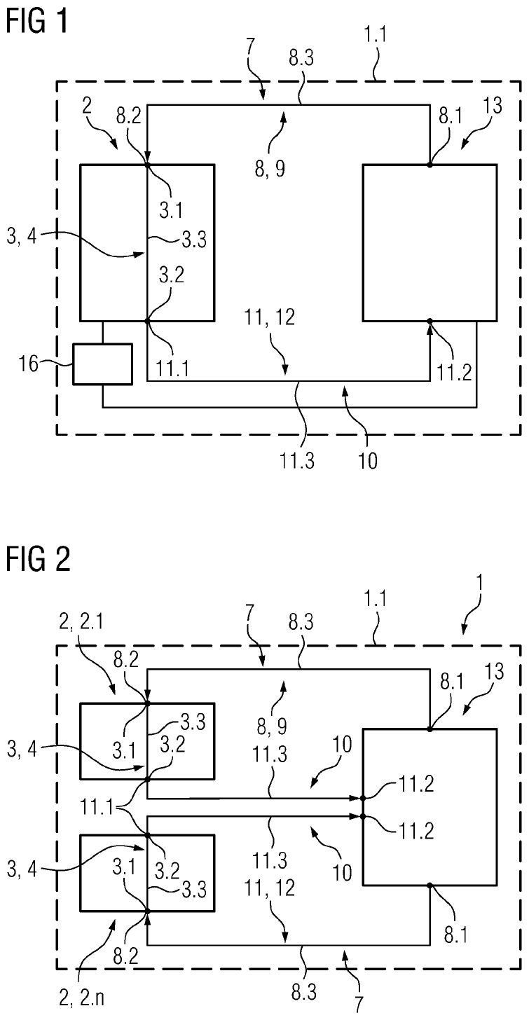

FIG. 1 is a schematic diagram of a device 1 for processing a particle foam material for producing a particle foam molded part according to a first embodiment. The device 1 can also be referred to as or considered to be a molding machine.

The device 1 is therefore designed for carrying out at least one working process for processing a particle foam material for producing a particle foam molded part. As is clear from the following, an expansion or connection process of a particle foam material for producing a particle foam molded part can be considered to be an example of a corresponding working process.

A particle foam material that can be or is to be processed by means of the device 1 is typically an expandable or expanded plastics particle material. The particle foam material may e.g. be formed by expandable or expanded plastics particles or may comprise expandable or expanded plastics particles. In this context, purely by way of example, reference is made to expanded and/or expandable polypropylene (PP or EPP), expanded and/or expandable polystyrene (PS or EPS) and expanded and/or expandable thermoplastic elastomer (TPE). Mixtures of expandable or expanded particle materials or particles that differ in at least one chemical and/or physical parameter are conceivable; the term “particle foam material” can therefore also cover mixtures of expandable or expanded particle materials or particles that differ in at least one chemical and/or physical parameter.

In the operation of the device 1, a working medium is used. A working medium is generally an, in particular liquid, vaporous or gaseous, energy-carrier medium, such as a liquid, i.e. in particular water, steam, i.e. in particular superheated steam, or a gas, which, in the operation of the device 1, absorbs or outputs energy, i.e. in particular thermal energy, kinematic energy, etc., or is designed to do this.

The device 1 comprises one or more functional units 2, 2.1-2.n, through at least portions of which the working medium flows or can flow during operation of the device 1. Even though the embodiment according to FIG. 1 only shows one functional unit 2, 2.1, purely by way of example, the device 1 may also comprise a plurality of functional units 2.1-2.n, as shown purely by way of example in the embodiment according to FIG. 2.

A corresponding functional unit 2 typically comprises a flow-duct structure 4 comprising at least one flow duct 3 through which the working medium that is or can be used in the operation of the device 1 flows or can flow. A relevant flow duct 3 typically comprises at least one flow-duct inlet 3.1, at least one flow-duct outlet 3.2 and at least one flow-duct path 3.3 extending between the at least one flow-duct inlet 3.1 and the at least one flow-duct outlet 3.2.

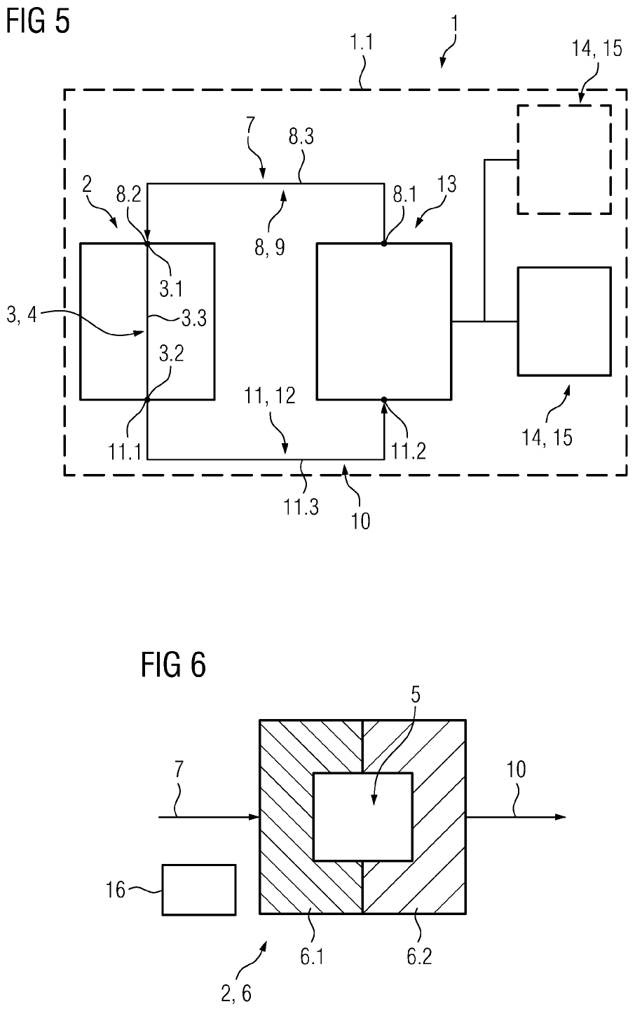

The or at least one functional unit 2 may e.g. be designed as or comprise a die unit 6 delimiting a molding cavity 5 (cf. e.g. the embodiment according to FIG. 6). A corresponding functional unit 2 may therefore be in the form of a die unit 6 for actually processing a particle foam material for producing a particle foam molded part. A corresponding die unit 6 may comprise one or more die unit elements, i.e. a part of the die elements 6.1, 6.2 or halves delimiting a molding cavity 5 delimited by the die unit 6 in each case, for example.

Furthermore, the or at least one functional unit 2 may e.g. be designed as or comprise a steam-generating unit for generating steam. A corresponding functional unit 2 may therefore be in the form of a steam-generating unit for generating steam, i.e. in particular superheated steam or saturated steam. A corresponding functional unit may in particular be designed for generating steam by converting water into steam, i.e. in particular superheated steam or saturated steam. A corresponding steam-generating unit may comprise one or more steam-generating elements, i.e. heating elements, for example.

Furthermore, the or at least one functional unit 2 may e.g. be designed as or comprise an, in particular chamber-like or chamber-shaped, steam storage unit for storing steam, in particular superheated steam or saturated steam, supplied to a die unit 6 delimiting a molding cavity. A corresponding functional unit 2 may therefore be in the form of a steam storage unit for storing steam, i.e. in particular superheated steam or saturated steam. A corresponding steam storage unit may comprise one or more steam storage elements, i.e. steam chamber elements, for example.

Furthermore, the or at least one functional unit 2 may e.g. be designed as or comprise a pressure-generating unit for generating pressure-modified working medium; “pressure-modified” is in particular understood to mean a working medium having a pressure level that is increased or reduced compared with a starting or reference pressure level. A corresponding functional unit 2 may therefore be in the form of a pressure-generating unit for generating pressure-modified working medium, i.e. in particular compressed air. A corresponding pressure-generating unit may for example be designed for generating compressed air by compressing air or for generating pressure-reduced air by depressurizing compressed air. A corresponding pressure-generating unit may comprise one or more pressure-generating elements, i.e. compressor or depressurizing elements, for example.

Furthermore, the or at least one functional unit 2 may e.g. be designed as or comprise an, in particular chamber-like or chamber-shaped, pressure storage unit for storing pressure-modified, in particular pressure-increased, working medium, for example compressed air, to be supplied to a die unit 6 delimiting a molding cavity 5. A corresponding functional unit 2 may therefore be in the form of a pressure storage unit for storing pressure-modified working medium, i.e. compressed air, for example. A corresponding pressure storage unit may comprise one or more pressure storage elements, i.e. pressure chamber elements, for example.

Furthermore, the or at least one functional unit 2 may be designed as or comprise a temperature-control unit, which is designed for temperature-controlling at least one additional functional unit, in particular for temperature-controlling a die unit 6 delimiting a molding cavity 5, of the device 1. A corresponding functional unit 2 may therefore be in the form of a temperature-control unit for temperature-controlling at least one additional functional unit, such as a die unit 6, a steam-generating unit, a steam storage unit, etc. A corresponding temperature-control unit may comprise one or more temperature-control elements, i.e. temperature-control duct elements through which a temperature-controllable or temperature-controlled medium flows or can flow, for example.

The device 1 further comprises at least one supply unit 7 for supplying the working medium to at least one corresponding functional unit 2. The supply unit 7 is therefore designed for supplying the working medium to at least one corresponding functional unit 2.

The supply unit 7 typically comprises a flow-duct structure 9 comprising at least one flow duct 8 through which the working medium flows or can flow. The flow-duct structure 9 may be formed by one or more line elements. A relevant flow duct 8 typically comprises at least one flow-duct inlet 8.1, at least one flow-duct outlet 8.2 and at least one flow-duct path 8.3 extending between the at least one flow-duct inlet 8.1 and the at least one flow-duct outlet 8.2. The supply unit 7 may further comprise a flow-generating unit (not shown), which is designed for generating a flow of the working medium to be supplied to a corresponding functional unit 2 or for controlling the flow of the working medium to be supplied to a corresponding functional unit 2. A corresponding flow-generating unit may e.g. be designed as or comprise a pump unit.

The device 1 further comprises at least one discharge unit 10 for discharging the working medium from at least one corresponding functional unit 2. The discharge unit 10 is therefore designed for discharging the working medium from at least one corresponding functional unit 2.

The discharge unit 10 typically comprises a flow-duct structure 12 comprising at least one flow duct 11 through which the working medium flows or can flow. The flow-duct structure 12 may be formed by one or more line elements. A relevant flow duct 11 typically comprises at least one flow-duct inlet 11.1, at least one flow-duct outlet 11.1 and at least one flow-duct path 11.3 extending between the at least one flow-duct inlet 11.1 and the at least one flow-duct outlet 11.2. The discharge unit 10 may further comprise a flow-generating unit (not shown), which is designed for generating a flow of the working medium to be discharged from a corresponding functional unit 2 or for controlling the flow of the working medium to be discharged from a corresponding functional unit 2. A corresponding flow-generating unit may e.g. be designed as or comprise a pump unit.

It is clear from FIG. 1 that a corresponding functional unit 2 is or can be connected to the supply unit 7 and the discharge unit 10 in terms of flow. There is therefore a fluidic connection (flow connection) between the functional unit 2, the supply unit 7 and the discharge unit 10, which connection makes it possible to supply to the functional unit 2 a working medium to be supplied to the functional unit 2 and/or to discharge from the functional unit 2 a working medium to be discharged from the functional unit 2.

The device 1 further comprises a preparation unit 13 that is or can be connected to the supply unit 7 and/or the discharge unit 10. The preparation unit 13 is designed for preparing the working medium. In particular, the preparation unit 13 is designed for preparing the or a working medium to be supplied to the functional unit 2 by means of the supply unit 7 and/or is designed for preparing the or a working medium to be discharged from the functional unit 2 by means of the discharge unit 10.

The preparation unit 13 may be designed for carrying out a plurality of preparation processes, i.e. in particular a plurality of different preparation processes, either at the same time or in a phased manner. A plurality of working media can therefore be prepared by means of the preparation unit 13 either at the same time or in a phased manner. In this process, different preparation processes can interact with one another in a targeted manner, in particular by exchanging the energy consumed or released as part of the respective preparation processes. For example, exothermic preparation processes for preparing a first working medium may influence, i.e. in particular induce or assist, endothermic preparation processes for preparing an additional working medium. For example, the thermal energy that is removed or is to be removed from a cooling working medium, i.e. a condensate, for example, in a first preparation process can be supplied to a working medium, i.e. a gas, to be heated, for example, in a second preparation process, or vice versa. The same applies to other types of preparation process. Where necessary, the preparation unit 13 may be equipped with energy exchangers, i.e. in particular heat exchangers, for this purpose.

The preparation unit 13 is in particular designed for preparing the or a working medium in respect of at least one particular target parameter. A target parameter may be a particular chemical and/or physical property of the working medium that is prepared or is to be prepared which is required or expedient for the use of the prepared working medium in a working process of the device 1. Therefore, it is possible to prepare a working medium originating from a first working process of the device 1 in respect of a reuse in the same working process of the device 1 or in respect of a use in another working process of the device 1.

In any case, the preparation unit 13 therefore makes it possible to prepare the or a working medium that is or can be used in the operation of the device and therefore provides the option of reusing the or a working medium, in particular multiple times, and the option of implementing direct media recycling within the device.

It is clear from FIG. 1 that the preparation unit 13 is connected to the device 1 by control technology. Therefore, the operation of the preparation unit 13, i.e. carrying out one or more preparation processes by means of the preparation unit 13, can be controlled by a control unit 16 of the device 1 implemented with hardware and/or software. There is therefore an, in particular multidirectional, data and communication connection between the control unit 16 of the device 1 and the preparation unit 13, i.e. in particular a controller (not shown) that controls the operation of the preparation unit 13, via which connection control information controlling at least the operation of the preparation unit 13 can be transferred to the preparation unit 13.

The device 1 therefore comprises a control unit 16, which is designed for generating control information controlling the operation of the preparation unit 13. The control unit 16 may in particular be designed for generating corresponding control information on the basis of current and/or future operational and/or process parameters of the device 1 or a functional unit 2 of the device 1. As mentioned, the control unit 16 is in a data connection to the preparation unit 13, i.e. in particular to a controller that controls the operation of the preparation unit 13, via an, in particular multidirectional, data and communication connection, via which control information controlling at least the operation of the preparation unit 13 can be transferred to the preparation unit 13.

The control unit 16 may be a central control unit of the device 1, which is designed for controlling the operation of at least one functional unit 2 of the device 1 and the operation of the preparation unit 13, i.e. for generating corresponding control information for controlling the operation of at least one functional unit 2 of the device 1 and the preparation unit 13.

It is also clear from FIG. 1 that the preparation unit 13 can be structurally connected to the device 1. For example, as shown in FIG. 1 purely by way of example, the preparation unit 13 may be structurally connected to an, in particular frame-like or rack-like, housing structure 1.1 of the device 1 (direct connection) or to at least one functional unit 2 of the device 2 that is structurally connected to a housing structure 1.1 of the device 1 (indirect connection). The preparation unit 13 may therefore be structurally integrated in the device 1.

The device 1 may therefore comprise an, in particular frame-like or rack-like, housing structure 1.1. The housing structure 1.1 of the device 1 is purely schematically shown in FIG. 1 by the dashed lines. The preparation unit 13 may be arranged or formed on or in the housing structure 1.1 or on or in a functional unit 2 arranged or formed on or in the housing structure 1.1, in particular via form-fitting and/or force-locked and/or material-bonded connection interfaces. As shown in FIG. 1, the functional unit 2, the supply unit 7 and the discharge unit 10 may also be arranged or formed on or in the housing structure 1.1 of the device 1 in addition to the preparation unit 13.

It is clear from FIG. 1 that the preparation unit 13 may be arranged so as to be connected between the at least one supply unit 7 and the at least one discharge unit 10. The arrangement of the preparation unit 13 relative to the supply unit 7 can therefore be selected such that a working medium prepared by means of the preparation unit 13 can be provided to the supply unit 7 via the preparation unit 13. The preparation unit 13 may therefore be arranged upstream of the supply unit 7 in terms of flow. The arrangement of the preparation unit 13 relative to the discharge unit 10 can therefore be selected such that a working medium prepared by means of the preparation unit 13 can be provided to the preparation unit 13 via the discharge unit 10. The preparation unit 13 may therefore be arranged downstream of the discharge unit 10 in terms of flow.

It is clear from FIG. 1 that the preparation unit 13 may be arranged so as to be connected between the supply unit 7 and the discharge unit 10, to form a flow circuit unit (not provided with a reference sign) that forms a closed flow circuit for the working medium. A corresponding flow circuit unit therefore forms an, in particular closed, flow circuit for the or a working medium, which flow circuit allows working medium to flow from the preparation unit 13 into the functional unit 2 and allows working medium to flow out of the functional unit 2 into the preparation unit 13. The working medium is supplied or flows from the preparation unit 13 into the functional unit 2 via or by means of the supply unit 7. The working medium is discharged or flows out of the functional unit 2 via or by means of the discharge unit 13. It follows that the flow circuit unit is formed by the functional unit 2, the preparation unit 13, the supply unit 7 and the discharge unit 13 or the functional unit 2, the preparation unit 13, the supply unit 7 and the discharge unit 13 may form parts of the flow circuit unit.

The flow ducts forming the flow-duct structure of the flow circuit unit therefore extend at least in portions, optionally completely, through the functional unit 2, the preparation unit 13, the supply unit 7 and the discharge unit 10.

In the embodiment shown in FIG. 1, purely by way of example, the flow circuit unit is formed by the flow-duct structures 4, 9, 12 of the functional unit 2, the supply unit 7 and the discharge unit 13. This embodiment shows a first flow duct, namely the flow duct 8 associated with the flow-duct structure 9 of the supply unit 7, which is designed or provided to allow working medium to be supplied or flow from the preparation unit 13 into the functional unit 2, and a second flow duct, namely the flow duct 11 associated with the flow-duct structure 12 of the discharge unit 10, which is designed or provided to allow working medium to be discharged or flow out of the functional unit 2 into the preparation unit 13.

The preparation unit 13 may be designed for modifying at least one chemical and/or physical parameter of the or a working medium. The working medium may therefore be prepared by modifying at least one chemical and/or physical parameter of the working medium. What modification to what chemical and/or physical parameter of the working medium specifically needs to be carried out for its preparation typically results from the current chemical and/or physical parameters of the working medium and the chemical and/or physical requirements of a particular working process in which the working medium that is prepared or is to be prepared is intended to be used.

The preparation unit 13 may e.g. be designed for modifying, i.e. in particular for increasing or reducing, the pressure of the or a working medium. The working medium may therefore be prepared by modifying the pressure of the working medium. To do this, the preparation unit 13 may be designed as or comprise a pressure-modifying unit. A corresponding pressure-modifying unit may e.g. be designed as or comprise a compressor unit.

Alternatively or additionally, the preparation unit 13 may e.g. be designed for modifying, i.e. in particular for increasing or reducing, the temperature of the or a working medium. Alternatively or additionally, the working medium may therefore be prepared by modifying the temperature of the working medium. To do this, the preparation unit 13 may be designed as or comprise a temperature-modifying unit. A corresponding temperature-modifying unit may e.g. be designed as or comprise a heating and/or cooling unit.

Alternatively or additionally, the preparation unit 13 may e.g. be designed for modifying, i.e. in particular for increasing or reducing, the physical state of the or a working medium. Alternatively or additionally, the working medium may therefore be prepared by modifying the physical state of the working medium. To do this, the preparation unit 13 may be designed as or comprise a physical-state-modifying unit. A corresponding physical-state-modifying unit may e.g. be formed by a corresponding pressure-modifying unit and a corresponding temperature-modifying unit.

Alternatively or additionally, the preparation unit 13 may e.g. be designed for modifying, i.e. in particular for increasing or reducing, the energy content of the or a working medium. Alternatively or additionally, the working medium may therefore be prepared by modifying the energy content, i.e. the enthalpy, for example, of the working medium. To do this, the preparation unit 13 may be designed as or comprise an energy-content-modifying unit. A corresponding energy-content-modifying unit may likewise e.g. be formed by a corresponding pressure-modifying unit and a corresponding temperature-modifying unit.

Alternatively or additionally, the preparation unit 13 may e.g. be designed for modifying, i.e. in particular for increasing or reducing, the flow properties, in particular the flow speed and/or the flow profile, of the or a working medium. Alternatively or additionally, the working medium may therefore be prepared by modifying the flow properties of the working medium. To do this, the preparation unit 13 may be designed as or comprise a flow-property-modifying unit. A corresponding flow-property-modifying unit may e.g. be formed by a pump unit, a nozzle unit or a diffuser unit.

Alternatively or additionally, the preparation unit 13 may be designed for modifying the chemical composition of the or a working medium. Alternatively or additionally, the working medium 13 may therefore be prepared by modifying the chemical composition of the working medium. To do this, the preparation unit 13 may be designed as or comprise a substance-concentration-modifying unit, which is designed for modifying the concentration of at least one substance forming a constituent of the working medium; a substance can be understood to be a pure substance or a substance compound, for example. A corresponding substance-concentration-modifying unit is in particular designed for modifying, i.e. in particular reducing or increasing, the concentration of at least one substance forming a constituent of the working medium from a first concentration, which may also be 0% or 100% in an extreme case, to a second concentration, which may also be 100% or 0% in an extreme case. One or more substances can therefore also be supplied to or removed from the working medium via a corresponding substance-concentration-modifying unit; the chemical composition of the working medium can be modified in this way.

Alternatively or additionally, the preparation unit 13 may be designed for removing in particular particulate impurities from the or a working medium. Alternatively or additionally, the working medium may therefore be prepared by removing impurities from the working medium and therefore by purifying the working medium. To do this, the preparation unit 13 may be designed as or comprise a purifying unit. A corresponding purifying unit may e.g. be designed as or comprise a filter unit.

Further configurations of the device 1 are clear from the embodiments shown in FIG. 2-5, purely by way of example.

FIG. 2 is a schematic diagram of a device 1 comprising a plurality of functional units 2, 2.1, 2.n and a preparation unit 13 assigned thereto. Here, the preparation unit 13 is designed for preparing the working medium discharged from the respective functional units 2, 2.1, 2.n or for preparing the working medium to be supplied to the respective functional units 2, 2.1, 2.n.

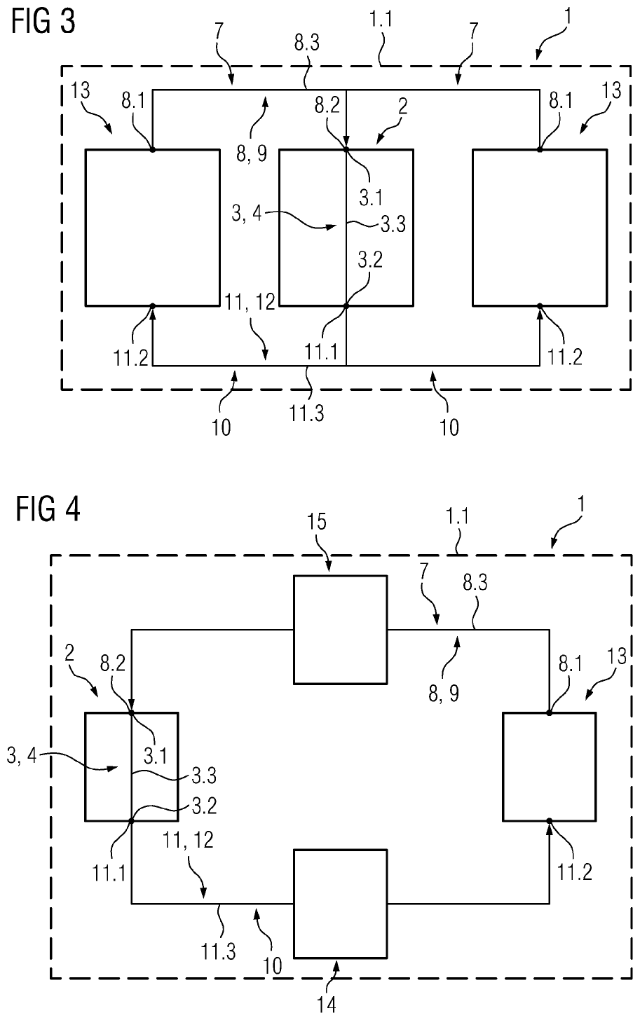

FIG. 3 is a schematic diagram of a device 1 comprising one functional unit and a plurality of preparation units 13 assigned thereto. Here, the respective preparation units 13 are designed for preparing the working medium discharged from the functional unit 2 or for preparing the working medium to be supplied to the functional unit 2.

Of course, combinations of the embodiments shown in FIGS. 2 and 3, therefore configurations having a plurality of functional units 2, 2.1, 2.n and a plurality of preparation units 13 that are or can be assigned thereto, are also conceivable.

FIG. 4 is a schematic diagram of a device 1 comprising an, in particular buffer-like or buffer-shaped, storage unit 14, which is arranged upstream of a preparation unit 13 and is designed for storing working medium to be supplied to the preparation unit 13, in particular for being prepared therein. Therefore, a working medium to be prepared by means of the preparation unit 13 may first be stored in the storage unit 14, i.e. in particular in a corresponding storage volume of the storage unit 14, and then, in particular as needed, may be supplied to the preparation unit 13. The storage unit 14 is therefore arranged so as to be connected between the functional unit 2 and the preparation unit 13, in the region of the discharge unit 10. Of course, a plurality of corresponding storage units 14 may be arranged between the functional unit 2 and the preparation unit 13. In this context, both arrangements or configurations of corresponding storage units 14 connected in parallel as well as arrangements or configurations of corresponding storage units 14 connected in series are conceivable. If a plurality of storage units 14 are provided, they may each have identical or different storage volumes.

FIG. 4 also shows that, alternatively or additionally, the device 1 may comprise an, in particular buffer-like or buffer-shaped, storage unit 15, which is or can be arranged downstream of the preparation unit 13 and is designed for storing working medium to be discharged from the preparation unit 13, in particular prepared working medium. Therefore, a working medium prepared by means of the preparation unit 13 may first be stored in the storage unit 15, i.e. in particular in a corresponding storage volume of the storage unit 15, and then, in particular as needed, may be supplied to the functional unit 2. The storage unit 15 is therefore arranged so as to be connected between the preparation unit 13 and the functional unit 2, in the region of the supply unit 7. Of course, a plurality of corresponding storage units 15 may be arranged between the preparation unit 13 and the functional unit 2. In this context, both arrangements or configurations of corresponding storage units 15 connected in parallel as well as arrangements or configurations of corresponding storage units 15 connected in series are conceivable. If a plurality of storage units 15 are provided, they may each have identical or different storage volumes.

In connection with the embodiment shown in FIG. 4, it is expressly stated that the device 1 may also only comprise one or more of the storage apparatuses 14 accordingly arranged upstream of the preparation unit 13 or one or more of the corresponding storage apparatuses 15 accordingly arranged downstream of the preparation unit 13.

FIG. 5 shows, purely by way of example, an arrangement of a storage apparatus 14, 15 that is different from that in FIG. 4 and is arranged so as to be connected in parallel with the preparation unit 13 here.

It is applicable to all the embodiments that, if a plurality of storage units 14, 15 are provided, these can be designed to be replaceable as needed and/or selectively. Individual storage units 14, 15, multiple storage units or all the storage units can therefore be replaced as needed and/or selectively; this can provide an option for supplying or discharging a working medium from the device 1 or from the flow system of the device 1.

FIG. 6 is a schematic diagram of an embodiment of a device 1 comprising one functional unit 2 in the form of a die unit 6 delimiting a molding cavity 5.

It shows that the die unit 6 comprises two die elements 6.1, 6.2 each delimiting a part of the molding cavity 5 delimited by the die unit 6. In this case, at least one die element 6.1, 6.2 is movably mounted relative to another die element 6.1, 6.2 in order to produce an open position and closed position of the die unit 6 in at least one degree of freedom.

In connection with the embodiment shown in FIG. 6, but in no way being restricted thereto, it is clear that the supply unit 7 may be designed for supplying the or a working medium to the die unit 6 for carrying out an expansion process of a particle foam material that is introduced into the molding cavity 5 and is to be processed by means of the device 1. The working medium that is or can be supplied via the supply unit 7 may therefore require an expansion process, i.e. generally a connection process, of a particle foam material that is introduced into the molding cavity 5 and is to be processed by means of the device 1. In this case, the working medium is typically an energy carrier, the properties of which allow for a corresponding expansion or connection process of a particle foam material that is introduced into the molding cavity 5 and is to be processed by means of the device 1. In order to carry out an expansion or connection process, a working medium containing a sufficient quantity of thermal energy, i.e. steam, superheated steam or saturated steam, for example, can be used.

Alternatively or additionally, the supply unit 7 may be designed for supplying the or a working medium for carrying out at least one conditioning process of at least one particle foam molded part that is produced in the molding cavity 5 by an expansion process of a particle foam material that is introduced into the molding cavity 5 and is to be processed by means of the device 1. A conditioning process may be an inerting, purifying, temperature-controlling or drying process, for example. The working medium that is or can be supplied by the supply unit 7 may therefore require at least one conditioning process, i.e. in particular an inerting, purifying, temperature-controlling or drying process, of a corresponding particle foam molded part. In this case, the working medium is typically an energy carrier, the properties of which allow for a corresponding conditioning process. The conditioning process may be carried out during or after the production of the particle foam molded part.

Alternatively or additionally, the supply unit 7 may be designed for supplying the or a working medium to the die unit 6 for carrying out at least one conditioning process of the die unit 6. A conditioning process may be an inerting, purifying, temperature-controlling or drying process, for example. The working medium that is or can be supplied by the supply unit 7 may therefore require at least one conditioning process, i.e. in particular an inerting, purifying, temperature-controlling or drying process, of the die unit 6. In this case, the working medium is typically an energy carrier, the properties of which allow for a corresponding conditioning process. The conditioning process may be carried out before, during or after an expansion process of a particle foam material that is introduced into the molding cavity 5 delimited by the die unit 6.

Alternatively or additionally, the supply unit 7 may be designed for supplying the or a working medium to the die unit 6, in particular in a state of the molding cavity 5 delimited by the die unit 6 in which it is not filled with a particle foam material to be processed, for carrying out at least one conditioning process of the die unit 6, i.e. in particular the molding cavity 5. A conditioning process may be an inerting, purifying, temperature-controlling or drying process, for example. The working medium that is or can be supplied by the supply unit 7 may therefore require at least one conditioning process, i.e. in particular an inerting, purifying, temperature-controlling or drying process, of the die unit 6, i.e. in particular the molding cavity 5. In this case, the working medium is typically an energy carrier, the properties of which allow for a corresponding conditioning process.

In all cases, an inert gas, such as argon, may be used for carrying out an inerting process. A purifying liquid, such as water, or a purifying gas, such as air, in particular purified air, may be used for carrying out a purifying process. A gas, such as air, in particular pressurized or compressed air, may be used for carrying out a drying process. A temperature-controlled liquid, such as temperature-controlled water, or a temperature-controlled gas, such as temperature-controlled air, in particular pressurized or compressed air, may be used for carrying out a temperature-controlling process.

In all cases, combinations of different conditioning processes, i.e. inerting processes and/or purifying processes and/or drying processes and/or temperature-controlling processes, for example, are conceivable. Corresponding conditioning processes may be carried out either at the same time or in a phased manner.

Corresponding conditioning processes, i.e. also the sequence thereof if there are a plurality of different conditioning processes, or corresponding conditioning requirements to be specifically applied in the context of corresponding conditioning processes may, in all cases, be controlled by a control unit 16 of the device 1 implemented with hardware and/or software. The control unit 16 is therefore designed for generating control information controlling the operation of the supply unit 7 and/or the discharge unit 10 for carrying out corresponding conditioning processes. The control unit 16 may in particular be designed for processing system-specific, user-specific or process-specific specifications for one or more conditioning processes, i.e. in particular to generate corresponding control information for controlling the operation of the supply unit 7 and/or the discharge unit 10 on the basis of corresponding specifications.

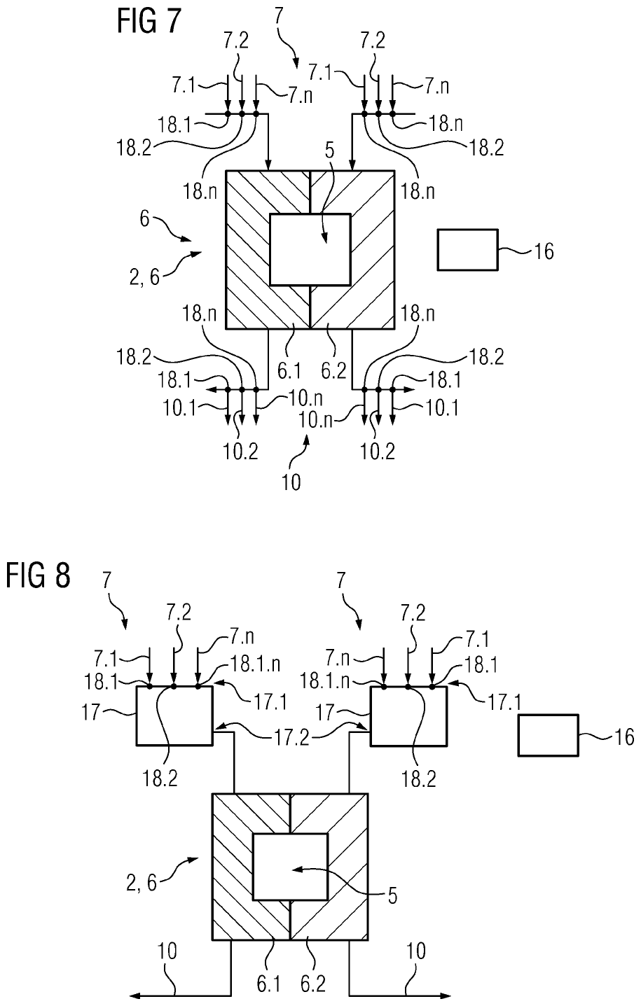

FIG. 7 is a schematic diagram of another embodiment of a device 1 comprising one functional unit 2 in the form of a die unit 6 delimiting a molding cavity 5.

The embodiment shows, purely by way of example, that the die unit 6 comprises two die elements 6.1, 6.2 or halves each delimiting a part of the molding cavity 5 delimited by the die unit 6.

It is clear from FIG. 7 that the supply unit 7 may comprise a plurality of supply lines 7.1-7.n. In the embodiment according to FIG. 7, purely by way of example, both the first die element 6.1 and the additional die element 6.2 each comprise three supply lines 7.1-7.n. The supply lines 7.1-7.n form parts of the supply unit 7.

A particular working medium can be supplied to the molding cavity 5 delimited by the die unit 6 by each of the supply lines 7.1-7.n. A control valve unit 18.1-18.n, which is purely schematically shown, is assigned to each supply line 7.1-7.n. Each control valve unit 18.1-18.n is movable, for example by opening a control valve element (not shown) that is movably mounted between an open position and a closed position, into a first state (open state) in which it is possible to supply a relevant working medium via the relevant supply line 7.1-7.n to the molding cavity 5, and is movable, for example by closing the or a control valve element that is movably mounted between an open position and a closed position, into a second state (closed state) in which it is not possible to supply a relevant working medium via the relevant supply line 7.1-7.n to the molding cavity 5.

In an analogous manner, the discharge unit 10 may not comprise a plurality of discharge lines 10.1-10.n, via each of which a particular working medium can be discharged from the molding cavity 5. A control valve unit 18.1-18.n is or can be assigned to each discharge line 10.1-10.n. Each control valve unit 18.1-18.n is movable, for example by opening a control valve element (not shown) that is movably mounted between an open position and a closed position, into a first state (open state) in which it is possible to discharge a relevant working medium via the relevant discharge line 10.1-10.n from the molding cavity 5, and is movable, for example by closing the or a control valve element that is movably mounted between an open position and a closed position, into a second state (closed state) in which it is not possible to discharge a relevant working medium via the relevant discharge line 10.1-10.n from the molding cavity 5.

Respective supply-apparatus-side control valve units 18.1-18.n and/or respective discharge-apparatus-side control valve units 18.1-18.n may be operated so as be dependent on or independent of one another, i.e. in particular may be moved into respective first and second states so as be dependent on or independent of one another.

Therefore, it is e.g. possible to supply a first working medium, which can be supplied to the molding cavity 5 or the die unit 6 via a first supply line 7.1, to the molding cavity 5 or the die unit 6 by moving a control valve unit 18.1 assigned to the first supply line 7.1 into a first state and to prevent an additional working medium, which can be supplied via an additional supply line 7.2, 7.n, from being supplied to the molding cavity 5 or the die unit 6 by moving the control valve unit 18.2, 18.n assigned to the additional supply line 7.2, 7.n into the second position. In particular, it is possible to move the control valve units 18.1-18.n assigned to the respective supply lines 7.1-7.n into a relevant first state separately, i.e. in particular in a phased manner or separately, such that, in particular when phased, it is possible to supply different working media to the molding cavity 5 or the die unit 6 in a separate or isolated manner via respective supply lines 7.1-7.n. Specifically, by moving a control valve unit 18.1 assigned to a first supply line 7.1 into the first state, while all the other control valve units 18.2, 18.n are or have been moved into the second state, a first working medium can be supplied to the molding cavity 5 or the die unit 6 and, at a later point in time, by moving a control valve unit 18.2, 18.n assigned to an additional supply line 7.2, 7.n into the first state, while the first control valve unit 18.1 is or has been moved into the second state, an additional working medium can be supplied to the molding cavity 5 or the die unit 6.

In an analogous manner, it is e.g. possible to discharge a first working medium, which can be discharged from the molding cavity 5 or the die unit 6 via a first discharge line 10.1, from the molding cavity 5 or the die unit 6 by moving a control valve unit 18.1 assigned to the first discharge line 10.1 into a first state and to prevent a second working medium, which can be discharged via an additional discharge line 10.2, 10.n, from being discharged from the molding cavity 5 or the die unit 6 by moving the control valve unit 18.2, 18.n assigned to the additional discharge line 10.2, 10.n into the second position. In particular, it is possible to move the control valve units 18.1-18.n assigned to the respective discharge lines 10.1-10.n into a relevant first state separately, i.e. in particular in a phased manner or separately, such that, in particular when phased, it is possible to supply different working media to the molding cavity 5 or the die unit 6 in a separate or isolated manner via respective discharge lines 10.1-10.n. Specifically, by moving a control valve unit 18.1 assigned to a first discharge line 10.1 into the first state, while all the other control valve units 18.2, 18.n are or have been moved into the second state, a first working medium can be discharged from the molding cavity 5 or the die unit 6 and, at a later point in time, by moving a control valve unit 18.2, 18.n assigned to an additional discharge line 10.1, 10.n into the first state, while the first control valve unit 18.1 is or has been moved into the second state, an additional working medium can be discharged from the molding cavity 5 or the die unit 6.

The operation of respective supply-apparatus-side and/or discharge-apparatus-side control valve units 18.1-18.n, i.e. in particular the movement thereof into the first or second state, may be controlled by a control unit 16 implemented with hardware and/or software. The control unit 16 is therefore designed for generating control information controlling the operation of respective supply-apparatus-side and/or discharge-apparatus-side control valve units 18.1-18.n. The control unit 16 may in particular be designed for processing system-specific, user-specific or process-specific specifications for operating one or more control valve units 18.1-18.n, i.e. in particular for generating corresponding control information for controlling the operation of respective supply-apparatus-side and/or discharge-apparatus-side control valve units 18.1-18.n on the basis of corresponding specifications.

FIG. 8 is a schematic diagram of another embodiment of a device 1 comprising one functional unit 2 in the form of a die unit 6 delimiting a molding cavity 5.

In this embodiment, the supply unit 7 is designed for supplying a working-medium mixture, containing at least two working media that differ in at least one chemical and/or physical parameter, to a die unit, i.e. in particular to the molding cavity 5 delimited by the die unit 6.

As applicable to all the embodiments, the or a working medium may therefore be a working-medium mixture containing at least two working media that differ in at least one chemical and/or physical parameter, i.e., for example, a mixture of at least one gas and at least one liquid or a mixture of at least two different gases or a mixture of at least two different liquids.

FIG. 8 shows, purely by way of example, that the device 1 comprises one or more mixing units 17, which are or can be assigned to the die unit 6, i.e. in particular the molding cavity 5, and is designed for mixing at least two working media that differ in at least one chemical and/or physical parameter to form a working-medium mixture.

Purely by way of example, the embodiment shown in FIG. 8 shows two mixing units 17, wherein a first mixing unit 17 is assigned to a first die element 6.1 and a second mixing unit 17 is assigned to a second die element 6.2.

Each mixing unit 17 typically comprises an input 17.1, via which a plurality of working media to be mixed can be supplied to the mixing unit 17, as indicated in FIG. 8 by the arrows, to generate a working-medium mixture, and an output 17.2, via which a working-medium mixture generated by means of the mixing unit 17 can be discharged from the mixing unit 17. The input 17.1 of the mixing unit 17 is typically connected to a plurality of supply lines 7.1.1-7.1.n (these supply lines 7.1.1-7.1.n may form parts of the supply unit 7) for supplying at least two different working media. At least two different working media can be supplied to the mixing unit 17 on the input side via the supply lines. The output 17.2 of the mixing unit 17 is typically connected to an, i.e. in particular exactly one, discharge line 7.n (this discharge line 7.n may likewise form part of the supply unit 7) for discharging a working-medium mixture generated by means of the mixing unit 17 from the mixing unit 17 into the die unit 6. A working-medium mixture to be supplied to the die unit 6 can therefore be discharged from the mixing unit 17 on the output side via the discharge line 10.1.

Each mixing unit 17 is in particular designed for generating working-medium mixtures having a particular composition, i.e. in particular a composition that is or can be predetermined in a system-specific, user-specific or process-specific manner. Each mixing unit 17 is therefore designed for generating particular mixing ratios, i.e. in particular mixing ratios of the working media supplied thereto that are or can be predetermined in a system-specific, user-specific or process-specific manner.

In order to produce particular compositions or particular mixing ratios, each mixing unit 17 may comprise at least one mixing space (not shown) delimiting at least one mixing volume and at least one control valve unit 18, 18.1, 18.n that is or can be assigned thereto. The control valve unit 18, 18.1, 18.n is designed for controlling a supply of a particular quantity of a first working medium provided via a first supply line 7.1.1 to be mixed with at least one additional working medium to the at least one mixing space and for controlling a supply of a particular quantity of at least one additional working medium provided via an additional supply line 7.1.n to be mixed with the first working medium to the at least one mixing space.

If, as shown purely by way of example in the embodiment according to FIG. 8, a plurality of control valve units 18.1-18.n are provided, a first control valve unit 18.1 may be designed for controlling a supply of a particular quantity of a first working medium provided via a first supply line 7.1.1 to be mixed with at least one additional working medium to the mixing space; a first supply line 7.1.1 may therefore be assigned to the first control valve unit 18.1, via which line a corresponding first working medium can be provided. At least one additional control valve unit 18.n may be designed for controlling a supply of a particular quantity of at least one additional working medium provided via at least one additional supply line 7.1.n to be mixed with the first working medium to the mixing space; an additional supply line may therefore be assigned to the at least one additional control valve unit 18.n, via which line at least one corresponding additional working medium can be provided.

The operation of the mixing unit 17, i.e. in particular the operation of the control valve units 18.1-18.n, may be controlled by a control unit 16 that is or can be assigned to the mixing units 17 and is implemented with hardware and/or software. The control unit 16 is therefore designed for generating control information controlling the operation of the mixing units 17 or the control valve units 18.1-18.n. The control unit 16 may in particular be designed for processing system-specific, user-specific or process-specific specifications for one or more mixing ratios, i.e. in particular for generating corresponding control information for controlling the operation of the mixing units 17 or the control valve units 18.1-18.n on the basis of corresponding specifications.

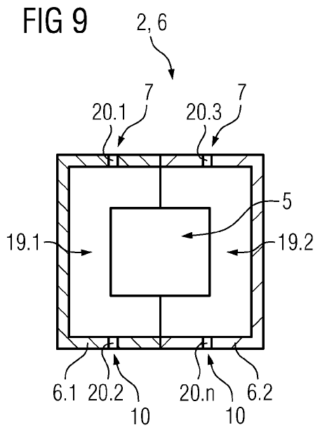

FIG. 9 is a schematic diagram of another embodiment of a device 1 comprising one functional unit 2 in the form of a die unit 6 delimiting a molding cavity 5.

The embodiment shows, purely by way of example, that the die unit 6 comprises two die elements 6.1, 6.2 or halves each delimiting a part of the molding cavity 5 delimited by the die unit 6.

It is clear from FIG. 9 that a relevant die element 6.1, 6.2 may comprise an, in particular chamber-like or chamber-shaped, working-medium receiving space 19.1, 19.2 for receiving steam. A corresponding die element 6.1, 6.2 may therefore delimit an internal steam-receiving volume, which is defined by a corresponding working-medium receiving space 19.1, 19.2 and is designed for receiving steam. The relevant working-medium receiving space 19.1, 19.2 is delimited by walls of the relevant die element 6.1, 6.2. It is clear that at least one of the walls delimiting the relevant working-medium receiving space 19.1, 19.2 is equally a wall delimiting the molding cavity 5 delimited by the relevant die element 6.1, 6.2. A plurality of openings (not shown in greater detail), via which a working medium, such as steam, compressed air, etc., can enter the molding cavity 5, are made in this wall. Therefore, the relevant working-medium receiving space 19.1, 19.2 is formed immediately behind a wall, delimiting the molding cavity 5, of a relevant die element 6.1, 6.2.

A relevant die element 6.1, 6.2 comprises a plurality of flow ducts 20.1-20.n, via which a working medium can be supplied to a corresponding working-medium receiving space 19.1, 19.2 and/or can be discharged from a corresponding working-medium receiving space 19.1, 19.2. It is clear from this embodiment, purely by way of example, that a relevant die element 6.1, 6.2 comprises a first flow duct 20.1, 201.3, which is designed for supplying a working medium, which is in particular a working medium that can be converted into steam in this case, to the at least one working-medium receiving space 19.1, 19.2, and comprises at least one additional flow duct 20.2, 20.n, which is designed for discharging a working medium from the at least one working-medium receiving space 19.1, 19.2.

In an exemplary, minimum configuration, a corresponding die element 6.1, 6.2 may comprise one (single) flow duct 20.1-20.n, which is designed for supplying a working medium to the working-medium receiving space 19.1, 19.2 and for discharging a working medium from the working-medium receiving space 19.1, 19.2. Typically, however, a corresponding die element 6.1, 6.2, as shown in FIG. 9, comprises at least one flow duct 20.1, 20.3 which is designed for supplying a working medium to the relevant working-medium receiving space 19.1, 19.2 and for discharging a working medium from the working-medium receiving space 19.1, 19.2 and at least one flow duct 20.2, 20.n which is designed for supplying a working medium to the relevant working-medium receiving space 19.1, 19.2 and for discharging a working medium from the working-medium receiving space 19.1, 19.2.

The respective die-element-side flow ducts 20.1-20.n may be designed as, in particular bore-like or bore-shaped, openings extending through respective die-element bodies. The path of respective flow ducts 20.1-20.n may be simple or complex; it is conceivable to provide an additively produced construction of the flow ducts 20.1-20.n, i.e. produced by means of an additive manufacturing method, such as a selective laser-melting method or a binder-jetting method.

The devices 1 according to the embodiments shown in the drawings can be used to implement a method for operating a device 1 for processing a particle foam material for producing a particle foam molded part, which method is characterized in that a working medium that is or can be used in the operation of the device 1 is prepared by means of a preparation unit 13, in particular by means of a preparation unit 13 integrated in the device 1.

Individual aspects and/or features, multiple aspects and/or features or all the aspects and/or features described in connection with a particular embodiment are transferable to individual aspects and/or features, multiple aspects and/or features or all the aspects and/or features described in connection with at least one other embodiment. The embodiments according to the drawings can therefore be combined with one another.

1. A device for processing a particle foam material for producing a particle foam molded part, comprising:
at least one functional unit, through at least portions of which at least one working medium that is or can be used in the operation of the device flows or can flow during operation of the device,
at least one supply unit for supplying the or at least one working medium that is or can be used in the operation of the device to the at least one functional unit,
at least one discharge unit for discharging the or at least one working medium that is or can be used in the operation of the device from the at least one functional unit, wherein:
at least one preparation unit which is or can be connected to the at least one supply unit and/or to the at least one discharge unit and is designed for preparing the or at least one working medium that is or can be used in the operation of the device.

2. The device according to claim 1, wherein the preparation unit is connected to the device by control technology.

3. The device according to claim 1, wherein at least the at least one preparation unit is arranged or formed on or in a housing structure.

4. The device according to claim 1 wherein the at least one preparation unit is arranged so as to be connected between the at least one supply unit and the at least one discharge unit.

5. The device according to claim 4, wherein the at least one preparation unit is arranged so as to be connected between the at least one supply unit and the at least one discharge unit, to form a flow circuit unit that forms a flow circuit for the at least one working medium that is or can be used in the operation of the device.

6. The device according to claim 1, wherein the at least one preparation unit is designed for modifying at least one chemical and/or physical parameter of the at least one working medium that is or can be used in the operation of the device.

7. The device according to claim 1, wherein the at least one preparation unit is designed for modifying the pressure of the at least one working medium that is or can be used in the operation of the device.

8. The device according to claim 1, wherein the at least one preparation unit is designed for modifying the temperature of the at least one working medium that is or can be used in the operation of the device.

9. The device according to claim 1, wherein the at least one preparation unit is designed for modifying the physical state of the at least one working medium that is or can be used in the operation of the device.

10. The device according to claim 1, wherein the at least one preparation unit is designed for modifying the energy content of the at least one working medium that is can be used in the operation of the device.

11. The device according to claim 1, wherein the at least one preparation unit is designed for modifying the flow properties, in particular the flow speed and/or the flow profile, of the at least one working medium that is or can be used in the operation of the device.

12. The device according to claim 1, wherein the at least one preparation unit is designed for modifying the chemical composition of the at least one working medium that is or can be used in the operation of the device.

13. The device according to claim 1, wherein the at least one preparation unit is designed for removing in particular particulate impurities from the working medium or at least one working medium that is or can be used in the operation of the device.

14. The device according to claim 1, wherein at least one storage unit, which is or can be arranged upstream of the at least one preparation unit and is designed for storing working medium to be supplied to the at least one preparation unit, and/or
at least one storage unit, which is or can be arranged downstream of the at least one preparation unit and is designed for storing working medium to be discharged from the at least one preparation unit.

15. The device according to claim 1, wherein the at least one supply unit is designed for supplying a working-medium mixture, containing at least two working media that differ in at least one chemical and/or physical parameter, to a die unit of the device that delimits a molding cavity.

16. The device according to claim 1, wherein a mixing unit, which is or can be assigned to a die unit that delimits a molding cavity and is designed for mixing at least two working media that differ in at least one chemical and/or physical parameter to form a working-medium mixture.

17. The device according to claim 1, wherein the supply unit is designed for at least one of: supplying the at least one working medium that is or can be used in the operation of the device to a die unit for carrying out an expansion process of a particle foam material that is introduced into the molding cavity and is to be processed by means of the device,
supplying the at least one working medium that is or can be used in the operation of the device for carrying out at least one conditioning process of at least one particle foam molded part that is produced in the molding cavity by an expansion process of a particle foam material that is introduced into the molding cavity and is to be processed by means of the device,
supplying the at least one working medium that is or can be used in the operation of the device to the die unit for carrying out at least one conditioning process of the die unit, and/or
supplying the at least one working medium that is or can be used in the operation of the device to a molding cavity delimited by the die unit, in particular in a state in which it is not filled with a particle foam material to be processed, for carrying out at least one conditioning process of the molding cavity delimited by the die unit.

18. The device according to claim 1, wherein a die unit delimiting a molding cavity comprises at least one working-medium receiving space for receiving steam.

19. The device according to claim 1, comprising a die unit comprising a first die element delimiting a first portion of the molding cavity and at least one additional die element delimiting an additional portion of the molding cavity, wherein
the first die element comprises at least one working-medium receiving space for receiving steam, wherein the first die element comprises one or more flow ducts, through which a working medium can be supplied to the at least one working-medium receiving space and/or discharged from the at least working-medium receiving space, and/or
the at least one additional die element comprises at least one, working-medium receiving space for receiving steam, wherein the at least one additional die element comprises one or more flow ducts, through which a working medium can be supplied to the at least one working-medium receiving space and/or discharged from the at least working-medium receiving space.

20. The device according to claim 1, wherein the at least one functional unit is designed as or comprises a die unit delimiting a molding cavity.

21. The device according to claim 1, wherein the at least one functional unit is designed as or comprises a steam-generating unit for generating steam.

22. The device according to claim 1, wherein the at least one functional unit is designed as or comprises an steam storage unit for storing steam supplied to a die unit delimiting a molding cavity.

23. The device according to claim 1, wherein the at least one functional unit is designed as or comprises a pressure-generating unit for generating pressure-modified working medium.

24. The device according to claim 1, wherein the at least one functional unit is designed as or comprises an pressure storage unit for storing pressure-modified working medium, supplied to a die unit delimiting a molding cavity.

25. The device according to claim 1, wherein the at least one functional unit is designed as or comprises a temperature-control unit, which is designed for temperature-controlling at least one additional functional unit of the device.

26. A preparation unit for preparing a working medium for a device for processing a particle foam material for producing a particle foam molded part according to claim 1.

27. A method for operating a device for processing a particle foam material for producing a particle foam molded part according to claim 1, wherein a working medium that is or can be used in the operation of the device is prepared by means of a preparation unit.
